(19) United States
(12) Patent Application Publication
(10) Pub. No.: US 2025/0042002 A1
(43) Pub. Date: Feb. 6, 2025

(54) TOOL BIT HAVING A BIMETAL TIP

(71) Applicant: MILWAUKEE ELECTRIC TOOL CORPORATION, Brookfield, WI (US)

(72) Inventors: James J. Van Essen, Hales Corners, WI (US); David Hlavac, Colgate, WI (US); Milorad Marich, Mequon, WI (US)

(21) Appl. No.: 18/912,895

(22) Filed: Oct. 11, 2024

Related U.S. Application Data
(63) Continuation of application No. 18/141,746, filed on May 1, 2023, now Pat. No. 12,122,019.
Application No. 18/141,746 is a continuation of application No. 17/798,284, filed on Aug. 8, 2022, now Pat. No. 11,673,239.
(60) Provisional application No. 62/975,787, filed on Feb. 13, 2020.

(51) Int. Cl. B25B 15/00; B25B 23/00

(52) U.S. Cl. CPC B25B 15/002; B25B 23/0035

(57) ABSTRACT

A tool bit may include a first end, a second end, and a longitudinal axis, an insertion end portion adjacent the first end, a working end portion adjacent the second end and configured to be inserted into a fastener a first distance measured from the second end. The working end portion including a first segment and a second segment that is fixed to the first segment at a connection interface, and a first maximum outer dimension measured perpendicular to the longitudinal axis. The connection interface is located a second distance measured from the second end. The tool bit further includes a shank disposed between the insertion end portion and the working end. The shank includes a second maximum outer dimension measured perpendicular to the longitudinal axis, wherein the second maximum outer dimension is less than the first maximum outer dimension.

### CROSS-REFERENCE TO RELATED APPLICATIONS

The present application is a continuation of U.S. patent application Ser. No. 18/141,746 filed on May 1, 2023, now U.S. Pat. No. 12,122,019, which is a continuation of U.S. patent application Ser. No. 17/798,284 filed on Aug. 8, 2022, now U.S. Pat. No. 11,673,239, which is a national stage filing under 35 U.S.C. § 371 of International Application No. PCT/US2021/017549 filed on Feb. 11, 2021, which claims priority to U.S. Provisional Patent Application No. 62/975,787 filed on Feb. 13, 2020, the contents of all of which are incorporated herein by reference.

### FIELD OF THE DISCLOSURE

The present disclosure relates to tool bits and, more particularly, to tool bits being composed of multiple materials.

### SUMMARY

The present disclosure provides, in one aspect, a tool bit including a first end, a second end, and a longitudinal axis extending between the first end and the second end; an insertion end portion adjacent the first end and configured to be connected to a tool; a working end portion adjacent the second end and configured to be inserted into a fastener a first distance measured from the second end, the working end portion including a first segment, a second segment that is fixed to the first segment at a connection interface, the connection interface located a second distance measured from the second end, wherein the first distance is less than the second distance, and a first maximum outer dimension measured perpendicular to the longitudinal axis; and a shank disposed between the insertion end portion and the working end, the shank including a second maximum outer dimension measured perpendicular to the longitudinal axis, wherein the second maximum outer dimension is less than the first maximum outer dimension.

The present disclosure provides, in another aspect, a tool bit including a first end, a second end, and a longitudinal axis extending between the first end and the second end; an insertion end portion adjacent the first end and configured to be connected to a tool, the insertion end being composed of a first material having a first hardness; and a working end portion adjacent the second end and configured to be inserted into a fastener a first distance measured from the second end, the working end portion including a first segment and a second segment, the second segment being fixed to the first segment at a connection interface and being composed of a second material having a second hardness that is greater than the first hardness by a percentage, the connection interface located a second distance measured from the second end, wherein the first distance is less than the second distance, and wherein the second distance is based on a first ratio of a maximum radial dimension at a location along the tool bit to a polar moment at the location, and wherein the first ratio is multiplied by the percentage.

The present disclosure provides, in another aspect, a tool bit including a first end, a second end, and a longitudinal axis extending between the first end and the second end; an insertion end portion adjacent the first end and configured to be connected to a tool, the insertion end being composed of a first material having a first hardness; and a working end portion adjacent the second end and configured to be inserted into a fastener a first distance measured from the second end, the working end portion is composed of a second material having a second hardness that is greater than the first hardness by a percentage, the working end including a first segment and a second segment that is fixed to the first segment via welding along a connection interface, thereby creating a heat affect zone, wherein the connection interface is at a calculated distance measured from the second end and the heat affect zone defines a second distance, wherein the calculated distance is based on a first ratio of a maximum radial dimension at a location along the tool bit to a polar moment at the location, and wherein the first ratio is multiplied by the percentage, wherein the second distance is further added to the calculated distance to determine the calculated distance of the connection interface when the first segment and the second segment are joined via welding.

Other aspects of the disclosure will become apparent by consideration of the detailed description and accompanying drawings.

### BRIEF DESCRIPTION OF THE DRAWINGS

FIG. 1 is a side view of a tool bit according to an embodiment of the disclosure.

FIG. 2 is an exploded side view of a portion of the tool bit of FIG. 1.

FIG. 3 is a flowchart illustrating a method of manufacturing the tool bit of FIG. 1.

FIG. 4 is a perspective view of a portion of a tool bit according to another embodiment of the disclosure.

FIG. 5 is a side view of a portion of the tool bit of FIG. 1 illustrating a weld zone of the tool bit.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and being practiced or being carried out in various ways. Also, it is to be understood that the phraseology and terminology used herein is for the purpose of description and should not be regarded as limiting. Terms of degree, such as “substantially,” “about,” “approximately,” etc. are understood by those of ordinary skill to refer to reasonable ranges outside of the given value, for example, general tolerances associated with manufacturing, assembly, and use of the described embodiments.

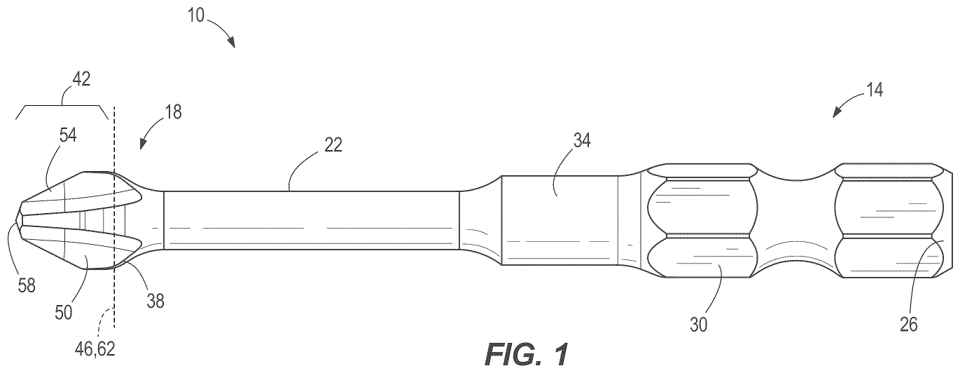

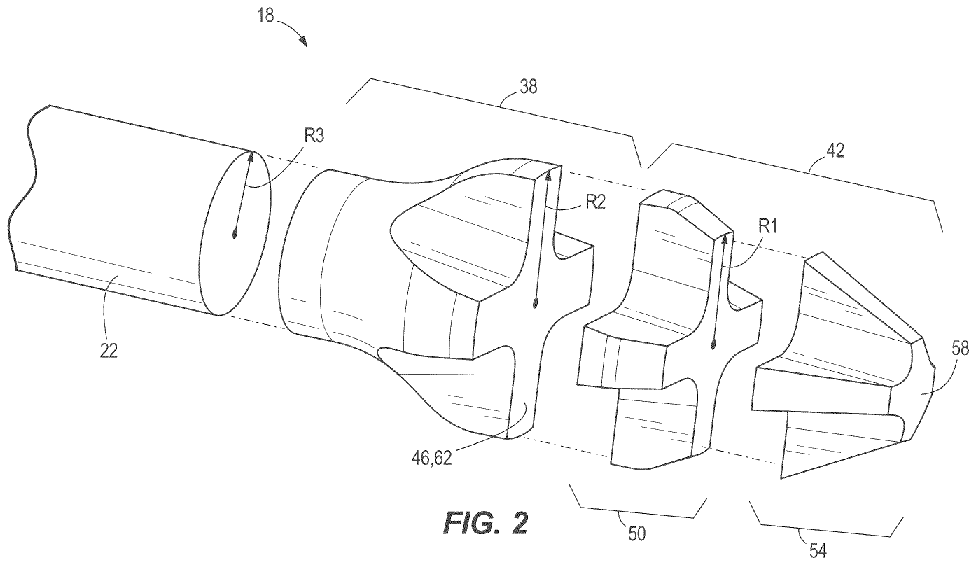

FIGS. 1 and 2 illustrate a tool bit 10 for use with a tool (e.g., a power tool and/or a hand tool). The illustrated tool bit 10 includes a tool body having an insertion end portion 14 (e.g., a hexagonal drive portion), a working end portion 18, and a connection portion 22 (e.g., a shank) extending between the working end portion 18 and the insertion end portion 14.

The insertion end portion 14 is configured to be connected to the tool. More particularly, the insertion end portion 14 is configured to be inserted into and received by a bit holder, chuck, or other structure coupled to or part of the tool. For ease of discussion, all of these types of structures will be referred to as bit holders herein. The insertion end portion 14 defines a first end 26 of the tool body that is opposite the working end portion 18. The insertion end portion 14 is composed of a first material. An outer surface on the insertion end portion 14 is at least partially defined by a non-circular profile 30. In the illustrated embodiment, the non-circular profile 30 is a hexagonal or hex-shaped profile configured to be received in a hexagonal or hex-shaped bit holder. In other embodiments, the non-circular profile 30 may be other suitable profiles, such as D-shaped, flattened, oblong, triangular, square, octagonal, star-shaped, irregular, and the like. A portion of the outer surface on the insertion end portion 14 not defined by the non-circular profile 30 is defined by a circular profile 34. In other embodiments, the circular profile 34 may be another profile, such as square, octagonal, star-shaped, irregular, and the like, or the circular profile 34 may be omitted. The circular profile 34 is proximate the connection portion 22.

The connection portion 22 is positioned between the working end portion 18 and the insertion end portion 14 (e.g., between the working end portion 18 and the circular profile 34). The connection portion 22 includes a circular cross-sectional shape and defines a maximum radial dimension R3 (e.g., a maximum radius; FIG. 2) relative to a longitudinal axis of the tool bit 10. In additional embodiments, the connection portion 22 may define a cross-sectional shape that is rectangular, octagonal, star-shaped, and the like. The connection portion 22 is also composed of the first material.

The working end portion 18 is configured to engage with a fastener (e.g., a screw). More particularly, the working end portion 18 is configured to drive the fastener into a workpiece. With reference to FIGS. 1 and 2, the working end portion 18 includes a first segment 38 (e.g., a rearward segment) separated from a second segment 42 (e.g., a forward segment) by a connection interface 46. As shown in FIG. 2, the connection interface 46 defines a maximum radial dimension R2 (e.g., a maximum radius) relative to the longitudinal axis of the tool bit 10. A cross-section of the working end portion 18 at the maximum radius R2 defines a cross. As such, the maximum radius R2 is measured relative to a circle circumscribed by the cross. In additional embodiments, the cross-section may define a rectangle, an oval, a star, and the like.

With continued reference to FIGS. 1 and 2, the illustrated forward segment 42 is composed of a second material and includes a first portion 50 and a second portion 54. The second portion 54 includes a second end 58 (e.g., a tip) of the tool body that is opposite the first end 26. The second portion 54 of the working end portion 18 is the portion of the tool bit 10 that is inserted into a recess of the fastener when the tool bit 10 engages and drives the fastener. As such, the second portion 54 can be referenced as a fastener engagement portion. In particular, the working end portion 18 is inserted into the fastener up to a depth measured from the second end 58 (e.g., the axial distance between the second end 58 and the interface between the first and second portions 50, 54). At this depth (e.g., a location at which fastener engagement ceases), an outer surface of the working end portion 18 defines a maximum radial dimension R1 (e.g., a maximum radius; FIG. 2) relative to the longitudinal axis of the tool bit 10. In the depicted embodiment, a cross-section of the working end portion 18 at the maximum radius R1 also defines a cross. As such, the maximum radius R1 is measured relative to a circle circumscribed by the cross. In additional embodiments, the cross-section may define a rectangle, an oval, a star, and the like. In the depicted embodiment, the radius R2 is larger than the radius R1. Additionally, the radius R1 and the radius R2 are both larger than the radius R3. Furthermore, a distance from the second end 58 to the location of the maximum radius R1 is less than a distance from the second end 58 to the location of the connection interface 46.

In the illustrated embodiment, the working end portion 18 is composed of the first material and the second material. The second material defines the second segment 42 (e.g., the first and second portions 50, 54), and the first material defines a remainder of the working end portion 18 (e.g., the first segment 38) not defined by the second material. In the depicted embodiment, the second material has a hardness that is greater than a hardness of the first material. In other words, the second segment 42 is harder than the first segment 38. In some embodiments, the hardness of the second material is at least 5% greater than the hardness of the first material. In other embodiments, the hardness of the second material is between 5% and 30% greater than the hardness of the first material.

In the depicted embodiment, the first material is a tool steel. In some embodiments, the first material may be a low carbon steel, such as AISI 1018. AISI 1018 low carbon steel includes a balance of toughness, strength, and ductility. AISI 1018 low carbon steel includes approximately 0.14% to 0.2% carbon and 0.6% to 0.9% manganese. In other embodiments, the first material may be a high carbon steel, such as AISI 1065. AISI 1065 high carbon steel includes a high tensile strength. AISI high carbon steel includes approximately 0.6% to 0.7% carbon and 0.6% to 0.9% manganese. In additional embodiments, the first material may be an alternative material. The tool steel may have a hardness, for example between about 45 HRC and about 60 HRC. In some embodiments, the tool steel may have a hardness of between about 45 HRC and about 55 HRC.

In the depicted embodiment, the second material is a high speed steel (HSS), such as PM M4. PM M4 high speed steel includes a fine grain size, small carbides, and a high steel cleanliness, which together provide high wear-resistance, high impact toughness, and high bend strength. PM M4 high speed steel includes approximately 1.4% carbon, 4% Chromium, 5.65% tungsten, 5.2% molybdenum, and 4% vanadium. In additional embodiments, the second material may be an alternative material (e.g., carbide). The high speed steel may have a hardness, for example, of 60 HRC or greater.

By using the high or low carbon steel as the first material and the PM M4 high speed steel as the second material, the cost to manufacture the tool bit 10 is minimized while the strength of the tool bit 10 is maintained. The cost to manufacture the tool bit 10 is minimized due to the material being used for the first material generally being inexpensive. The second material compensates for a lower strength of the first material.

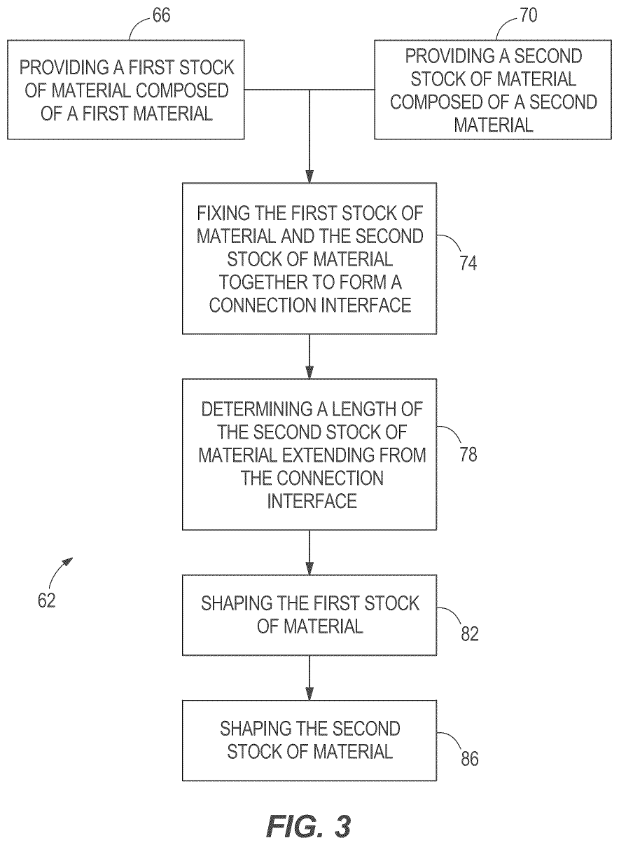

FIG. 3 illustrates a method 62 of manufacturing the tool bit 10. Although the illustrated method 62 includes specific steps, not all of the steps need to be performed. In addition, the depicted steps do not need to be performed in the order presented. The method 62 may also include additional or alternative steps.

The illustrated method 62 includes providing a first stock of material (step 66) composed of the first material and providing a second stock of material (step 70) composed of the second material. Step 74 includes fixing the first stock of material to the second stock of material (e.g., the forward segment 42 composed of the second material is secured to the rearward segment 38 composed of the first material). The segments 38, 42 are fixed together at the connection interface 46. In the illustrated embodiment, the segments 38, 42 are fixed together by a welding process. The first and second stocks of material may be welded via spin welding, resistance welding, laser welding, friction welding, and the like. In other embodiments, the segments 38, 42 are fixed together by a different process (e.g., a brazing process or the like). In the depicted embodiment, the first stock of material is a hex-shaped blank and the second stock of material is a cylinder-shaped blank. In additional embodiments, the first and second stocks of material may differ in shape.

An axial length of the second stock of material extending from the connection interface 46 is determined (step 78) as discussed in more detail below. The first stock of material and the second stock of material may then be machined or shaped (steps 82, 86) to form the tool bit 10. Shaping the second stock of material (step 86) is based on the determined length (step 78) of the second stock of material. The first stock of material forms the first end 26 to the connection interface 46, and the second stock of material forms the second end 58 to the connection interface 46. In other words, the first stock of material is shaped to form the insertion end portion 14, the connection portion 22, and the rearward portion 38. The second stock of material is shaped to form the working end portion 18 from the second end 58 to the connection interface 46 (e.g., the forward segment 42). In other embodiments, the method 62 can be different (e.g., the axial length of the second stock can be determined before the first and second stock of material are fixed together).

To determine a location of the connection interface 46 (step 78), the torsional stress τ_{R1} is calculated at the radius R1. The torsional stress τ_{R1} is related to an applied torque τ_{R1}, the radius R1 that the stress is occurring at, and a polar moment of inertia of the cross section J_{T}_{_{R1}} at the radius R1. The torsional stress τ_{R1} at the radius R1 is expressed in Equation 1.

$${τ}_{R 1} = \frac{{T}_{R 1} * R 1}{{J}_{{T}_{R 1}}} \qquad ( Eqn . 1 )$$

The torsional stress τ_{R2} allowed at the radius R2 may then be calculated based on the torsional stress τ_{R1} at the radius R1. The torsional stress τ_{R2} allowed at the radius R2 is a percentage P of the torsional stress τ_{R1} at the radius R1. The percentage P is based on the difference in hardness between the first material and the second material. For example, if the first material was 80% the hardness of the second material, the torsional stress τ_{R2} allowed at the radius R2 would be 80% the torsional stress τ_{R1} at the radius R1. The torsional stress τ_{R2}allowed at the radius R2 is expressed in Equation 2.

$${τ}_{R 2} = P * \frac{{T}_{R 1} * R 1}{{J}_{{T}_{R 1}}} \qquad ( Eqn . 2 )$$

In addition to the torsional stress τ_{R2} allowed at the radius R2 being expressed in Equation 2, the torsional stress τ_{R2} allowed at the radius R2 may be related to the applied torque T_{R2}, the radius R2, and a polar moment of inertia of the cross section J_{T}_{_{R2}} at the radius R2. The torsional stress τ_{R2} allowed at the radius R2 is expressed in Equation 3.

$${τ}_{R 2} = \frac{{T}_{R 2} * R 2}{{J}_{{T}_{R 2}}} \qquad ( Eqn . 3 )$$

Equation 2 may be equated to Equation 3. Since the applied torque is the same through the drill bit, the torque T_{R1} at the radius R1 is the same as the torque T_{R2} at the radius R2. This expression is shown in Equation 4.

$$P * \frac{R 1}{{J}_{{T}_{R 1}}} = \frac{R 2}{{J}_{{T}_{R 2}}} \qquad ( Eqn . 4 )$$

The connection interface 46 may be selected such that the ratio of the radius R2 to the polar moment of the cross section J_{T}_{_{R2}} at the radius R2 is less than or equal to the ratio of the radius R1 to the polar moment of the cross section J_{T}_{_{R1}} at the radius R1 multiplied by the percentage P difference between the hardnesses of the first material and the second material.

In some embodiments, the tool bit 10 may have a reduced diameter portion (e.g., the illustrated connection portion 22) that allows the tool bit 10 to twist along its length. If the tool bit 10 includes this type of reduced diameter portion, the allowed torsional stress at the radius R2 is calculated to account for the reduced diameter portion. The radius R3 is located within the reduced diameter portion. The allowed torsional stress at the radius R2 is illustrated in Equation 5, which is similar to Equation 4.

$$P * \frac{R 3}{{J}_{{T}_{R 3}}} = \frac{R 2}{{J}_{{T}_{R 2}}} \qquad ( Eqn . 5 )$$

The connection interface 46 may be selected in view of both Equation 5 and Equation 4. In other words, the ratio of the radius R2 to the polar moment of the cross section J_{T}_{_{R2}} at the radius R2 is additionally less than or equal to the ratio of the radius R3 to the polar moment of the cross section J_{T}_{_{R3}} at the radius R3 multiplied by the percentage P difference between the hardnesses of the first material and the second material.

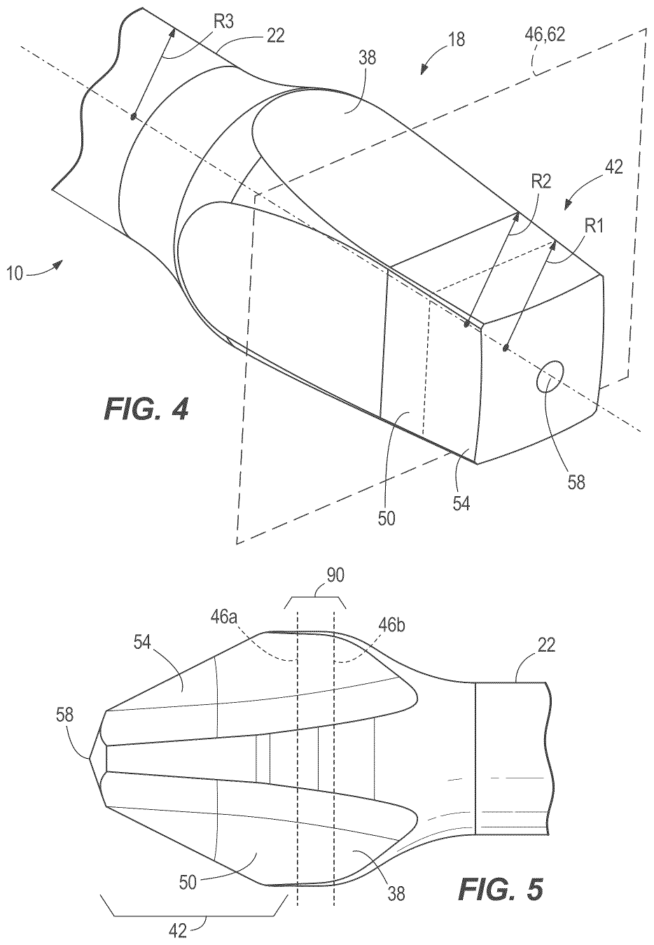

An axial distance of the connection interface 46 from the second end 58 may be determined (step 78) based on the ratio of the radius R2 to the polar moment of the cross section J_{T}_{_{R2}} at the radius R2. In other words, a radius and a polar moment may be calculated along a length of the working end portion 18 to determine where the correct ratio occurs. For example, the axial distance of the connection interface 46 of a square tip tool bit 10 (e.g., size #2 square bit; FIG. 4) is based on the ratio of the radius R2 to the polar moment of the cross section J_{T}_{_{R2}} at the radius R2, as depicted in the table below. In this example, the hardness of the first material is 80% of the hardness of the second material, and the engagement distance (i.e., the location of the maximum radius R1) is about 0.08 inches from the second end 58. As such, the ratio of the radius R1 to the polar moment of the cross section J_{T}_{_{R1}} at the radius R1 is 2614.5. Using Equation 4 above, 80% of 2614.5 is 2091.6, which is the target ratio for R2. Based on the table below, the calculated ratio for radius R2 to the polar moment of the cross section J_{T}_{_{R2}} at the radius R2 is equal to or less than 2091.6 when the distance from the second end 58 is 0.16 inches. As such, the connection interface 46 between the first material and the second material for a size #2 square bit should be at about 0.16 inches from the second end 58.

| Distance from the second end (inches) | Polar Moment of Inertia of the cross section | Radius (inches) | $\frac{R 2}{{J}_{{T}_{R 2}}}$ |
|---|---|---|---|
| 0.08 | 0.00003117 | 0.081496 | 2614.567 |
| 0.1 | 0.00003328 | 0.083071 | 2496.12 |
| 0.12 | 0.00003608 | 0.084646 | 2346.055 |
| 0.14 | 0.00004029 | 0.08622 | 2139.997 |
| 0.16 | 0.00004613 | 0.087795 | 1903.214 |

Determining the axial distance of the connection interface 46 of the #2 square bit, as described above, can be applied to different sizes and/or types of bits 10. The table below provides some examples of different sizes and types of bits 10 and maintains that the hardness of the first material is 80% of the hardness of the second material. Specifically, the first column in the table below represents the type and size of the bit 10 (e.g., PH1 is a size #1 Phillips-head bit, PZ1 is a size #1 Pozidriv-head bit, SQ1 is a size #1 square-head bit, and T10 is a size #10 Torx-head bit). In other words, the number associated with the type/geometry of the bit represents the standard size of the bit head. The table below shows, for example, the axial distance of the connection interface 46 of a size #1 Phillips-head bit relative to the tip 58 is about 0.087 inches. Specifically, a typical axial distance between the tip 58 and the radius R1 (e.g., a depth at which a #1 Phillips-head bit is received within a fastener) is about 0.075 inches. At that axial length, the polar moment of the cross section J_{T}_{_{R1}} at radius R1 is 0.00000840 and radius R1 is 0.058544 inches, such that a ratio of the radius R1 to the polar moment of the cross section J_{T}_{_{R1}} at the radius R1 is 6969.524. Taking in account for the differential between the hardnesses of the first and second materials, 80% of 6969.524 is about 5575.62, which is the target ratio for R2. As shown in the table below, the calculated ratio for radius R2 to the polar moment of the cross section J_{T}_{_{R2}} at the radius R2 is equal to or less than 5575.62 when the distance from the second end 58 is about 0.087 inches. As such, the connection interface 46 between the first material and the second material for a size #1 Phillips-head bit should be at about 0.087 inches from the second end 58. Similar calculations can be performed for the other types of tool bits 10 within the table below.

| | Distance | Distance | | | |
|---|---|---|---|---|---|
| | between | between the | | | |
| | the radius | connection | | | |
| | R1 and | interface | Polar | | |
| | the second | and the | Moment of | | |
| Tip Type | end (inches) | second end (inches) | Inertia of the cross section | Radius (inches) | $\frac{R 2}{{J}_{{T}_{R 2}}}$ |
| PH1 | 0.075 | | 0.00000840 | 0.058544 | 6969.524 |
| | | 0.087 | 0.00001190 | 0.063900 | 5369.748 |
| PH2 | 0.118 | | 0.00004889 | 0.097677 | 1997.897 |
| | | 0.138 | 0.00007068 | 0.107480 | 1520.661 |
| PH3 | 0.135 | | 0.00011500 | 0.118110 | 1027.043 |
| | | 0.205 | 0.00014610 | 0.118110 | 808.419 |
| PZ1 | 0.07 | | 0.00000729 | 0.057489 | 7886.008 |
| | | 0.083 | 0.00000990 | 0.062500 | 6313.131 |
| PZ2 | 0.13 | | 0.00006320 | 0.104194 | 1648.639 |
| | | 0.16 | 0.00008610 | 0.113870 | 1322.532 |
| PZ3 | 0.15 | | 0.00012400 | 0.118110 | 952.500 |
| | | 0.25 | 0.00016247 | 0.118110 | 726.965 |
| SQ1 | 0.08 | | 0.00001498 | 0.066487 | 4438.385 |
| | | 0.13 | 0.00001984 | 0.069000 | 3477.823 |
| SQ3 | 0.09 | | 0.00005847 | 0.095134 | 1627.057 |
| | | 0.16 | 0.00007818 | 0.099180 | 1268.611 |
| T10 | 0.07 | | 0.00000702 | 0.053357 | 7600.712 |
| | | 0.12 | 0.00000922 | 0.055970 | 6070.499 |
| T25 | 0.1 | | 0.00004716 | 0.086691 | 1838.232 |
| | | 0.16 | 0.00006120 | 0.089000 | 1454.248 |
| T30 | 0.12 | | 0.00011100 | 0.108388 | 976.468 |
| | | 0.19 | 0.00014840 | 0.113250 | 763.140 |
| T40 | 0.13 | | 0.00024560 | 0.130452 | 531.156 |
| | | 0.212 | 0.00032340 | 0.136861 | 423.194 |

In other types of tool bits 10, a T15 bit includes a distance between the connection interface 46 and the tip 58 of about 0.12 inches with a fastener engagement depth of about 0.07 inches, a T25 bit includes a distance between the connection interface 46 and the tip 58 of about 0.16 inches with a fastener engagement depth of about 0.1 inches, and a T27 bit includes a distance between the connection interface 46 and the tip 58 of about 0.175 inches with a fastener engagement depth of about 0.11 inches.

With reference to FIG. 5, welding the first material to the second material may create a heat affect zone 90. The heat affect zone 90 has a lower material strength than a material strength of the second material. A distance at which the heat affect zone 90 has affected the second material is added to the axial distance of the original connection interface 46a to offset a desired connection interface 46b an additional amount. For example, if the heat affect zone 90 is 0.11 inches and the initially calculated axial distance of the connection interface 46a is 0.16 inches from the second end 58, a revised connection interface 46b to account for the heat affect zone 90 would be 0.27 inches from the second end 58.

In some scenarios, the tool bit 10 may be stress relieved or heat treated after the first material is welded to the second material. In such scenarios, the heat affect zone 90 may be neglected, and an offset for the connection interface 46 would not need to be calculated.

Although the disclosure has been described in detail with reference to certain preferred embodiments, variations and modifications exist within the scope and spirit of one or more independent aspects of the disclosure as described. Various features and advantages of the disclosure are set forth in the following claims.

1. A tool bit comprising:
a first end, a second end, and a longitudinal axis extending between the first end and the second end;
an insertion end portion adjacent the first end and configured to be connected to a tool;
a working end portion adjacent the second end and configured to be inserted into a fastener a first distance measured from the second end, the working end portion including:
a first segment,
a second segment that is fixed to the first segment at a connection interface, the connection interface located a second distance measured from the second end, wherein the first distance is less than the second distance, and
a first maximum outer dimension measured perpendicular to the longitudinal axis; and
a shank disposed between the insertion end portion and the working end, the shank including a second maximum outer dimension measured perpendicular to the longitudinal axis, wherein the second maximum outer dimension is less than the first maximum outer dimension.

2. The tool bit of claim 1, wherein the insertion end portion and the shank are both composed of a first material.

3. The tool bit of claim 2, wherein the first segment of the working end is composed of the first material and the second segment of the working end portion is composed of a second material that has a hardness greater than a hardness of the first material.

4. The tool bit of claim 3, wherein the second segment includes a first portion and a second portion, wherein the second portion includes the second end of the tool bit and is configured to be inserted into the fastener, wherein the first maximum outer dimension is measured at the connection interface, wherein the first portion defines a third maximum outer dimension at an interface with the second portion, and wherein the first maximum outer dimension is larger than the third maximum outer dimension.

5. The tool bit of claim 4, wherein the first maximum outer dimension is a first maximum radius.

6. The tool bit of claim 4, wherein the second maximum outer dimension is a second maximum radius, and wherein the third maximum outer dimension is a third maximum radius.

7. The tool bit of claim 4, wherein a ratio of the first maximum outer dimension to a polar moment of a cross section at the first maximum outer dimension is less than or equal to a ratio of the third maximum outer dimension to a polar moment of a cross section at the third maximum outer dimension multiplied by a percentage difference between a hardness of the first material and a hardness of the second material.

8. The tool bit of claim 4, wherein a ratio of the first maximum outer dimension to a polar moment of a cross section at the first maximum outer dimension is less than or equal to a ratio of the second maximum outer dimension to a polar moment of a cross section at the second maximum outer dimension multiplied by a percentage difference between a hardness of the first material and a hardness of the second material.

9. The tool bit of claim 1, wherein the second segment is welded to the first segment at the connection interface.

10. A tool bit comprising:
a first end, a second end, and a longitudinal axis extending between the first end and the second end;
an insertion end portion adjacent the first end and configured to be connected to a tool, the insertion end being composed of a first material having a first hardness; and
a working end portion adjacent the second end and configured to be inserted into a fastener a first distance measured from the second end, the working end portion including a first segment and a second segment, the second segment being fixed to the first segment at a connection interface and being composed of a second material having a second hardness that is greater than the first hardness by a percentage, the connection interface located a second distance measured from the second end, wherein the first distance is less than the second distance, and
wherein the second distance is based on a first ratio of a maximum radial dimension at a location along the tool bit to a polar moment at the location, and wherein the first ratio is multiplied by the percentage.

11. The tool bit of claim 10, wherein the second distance is determined when a second ratio of a maximum radial dimension of the connection interface to a polar moment of the connection interface is less than or equal to the first ratio.

12. The tool bit of claim 10, further comprising a shank extending between the insertion end portion and the working end portion, wherein the location is disposed on the shank.

13. The tool bit of claim 10, wherein the location is disposed on the second segment, and wherein the second segment is configured to be received within the fastener to the location on the second segment in which the fastener ceases to engage the second segment.

14. The tool bit of claim 10, wherein the second segment is welded to the first segment at the connection interface.

15. The tool bit of claim 10, wherein the first material is tool steel, and wherein the second material is high speed steel.

16. A tool bit comprising:
a first end, a second end, and a longitudinal axis extending between the first end and the second end;
an insertion end portion adjacent the first end and configured to be connected to a tool, the insertion end being composed of a first material having a first hardness; and
a working end portion adjacent the second end and configured to be inserted into a fastener a first distance measured from the second end, the working end portion being composed of a second material having a second hardness that is greater than the first hardness by a percentage, the working end including a first segment and a second segment that is fixed to the first segment via welding along a connection interface, thereby creating a heat affect zone,
wherein the connection interface is at a calculated distance measured from the second end plus a second distance of the heat affect zone.

17. The tool bit of claim 16, wherein the heat affect zone has a lower material hardness than the second hardness.

18. The tool bit of claim 16, wherein the calculated distance is based on a first ratio of a maximum radial dimension at a location along the tool bit to a polar moment at the location, and wherein the first ratio is multiplied by the percentage.

19. The tool bit of claim 18, wherein the calculated distance measured from the second end to the connection interface is determined when a second ratio of a maximum radial dimension of the connection interface to a polar moment of the connection interface is less than or equal to the first ratio.

20. The method of claim 18, further comprising a shank coupled to the insertion end portion, wherein the location is included on the shank.
